(19) United States
(12) Patent Application Publication
(10) Pub. No.: US 2004/0035614 A1
(43) Pub. Date: Feb. 26, 2004

(54) Portable scale

(76) Inventor: Bin Zhang, Walnut, CA (US)

Correspondence Address: JOE NIEH, 17800 CASTLETON STREET, SUITE 475, CITY OF INDUSTRY, CA, 91748, US

(21) Appl. No.: 10/226,026

(22) Filed: Aug. 22, 2002

(51) Int. Cl. G01G 21/28

(52) U.S. Cl. 177/180

(57) ABSTRACT

A small lightweight portable scale with a convertible cover 2 that may be used to weigh small objects easily. The convertible cover 2 of the portable scale covers the weighing surface 4 of the portable scale while the portable scale is in transport or in storage to protect the weighing surface 4 and the delicate sensors under the weighing surface 4 from being damaged due to impact or excessive pressure during transport or storage. The convertible cover 2 is flipped open and rotated onto the weighing surface 4 when the portable scale is used to weigh objects. The convertible cover 2 acts as a holding dish to contain the small objects such that they will not roll or fall off the weighing surface 4 when they are being weighed and also to protect the weighing surface 4 from being damages by the objects being weighed

### BACKGROUND

1. Field of Invention

The present invention relates generally to portable scales for weighing small objects More specifically, the present invention relates to small lightweight portable scale with a cover for weighing small objects

2. Description of Related Art

Scales comes in various sizes and shapes for weighing different objects The objects may include anything ranging from trucks and airplanes to letters and minute quantities of powders and liquids. Naturally, the weight of the objects may also range from billions of tons or more to millionth of an ounce or less Therefore, various scales are necessary to determine the weight of the variety of objects and weights. Large objects with heavy weights require a large scale that are generally large in size themselves and are immobile. Small objects with light weights require a small scale that are generally small in size themselves and may be immobile or, more commonly, highly mobile

Large scales generally are relatively insensitive and measure the weight of the object in relatively large incremental units than small scales. Small scales, on the other hand, are relatively sensitive within a small weight range and weigh objects in relatively small and accurate incremental units Small scales, particularly small portable scales, are especially prone to damage due to impact or excessive pressure to its weighing surface during transport because their weighing surfaces are more delicate and more sensitive and also because of their delicate sensors with a limited weighing range In addition, the small objects that they are designed to weigh tend to be hard to handle and may roll or fall off the weighing surface easily. Furthermore, certain small objects may tend to either physically scratch or chemically erode the weighing surface when they come in contact with the weighing surface.

The present invention is a small portable scale that may be used to weigh small objects easily The portable scale has a convertible cover that covers the weighing surface to protect the weighing surface and the delicate sensors under the weighing surface from being damaged due to impact or excessive pressure The convertible cover is flipped open and rotated onto the weighing surface when the portable scale is used to weigh objects. The convertible cover acts as a holding dish to contain the small objects such that they will not roll or fall off the weighing surface when they are being weighed and also to protect the weighing surface from being damages by the objects being weighed.

### SUMMARY OF THE INVENTION

The present invention is a small lightweight portable scale that may be used to weigh small objects easily. The portable scale has a convertible cover that covers the weighing surface of the portable scale while the portable scale is in transport or in storage to protect the weighing surface and the delicate sensors under the weighing surface from being damaged due to impact or excessive pressure during transport or storage. The convertible cover is flipped open and rotated onto the weighing surface when the portable scale is used to weigh objects. The convertible cover acts as a holding dish to contain the small objects such that they will not roll or fall off the weighing surface when they are being weighed and also to protect the weighing surface from being damages by the objects being weighed

### BRIEF DESCRIPTION OF THE DRAWINGS

FIG. 1 shows the portable scale with its convertible cover closed, covering the weighing surface, and ready for transportation or storage.

FIG. 2 shows the portable scale with its convertible cover opened partially.

FIG. 3 shows the portable scale with its convertible cover opened completely.

FIG. 4 shows the portable scale with its convertible cover being rotated onto the weighing surface

FIG. 5 shows the portable scale with its convertible cover opened and rotated to rest on top of the weighting surface ready to receive the object to be weighed

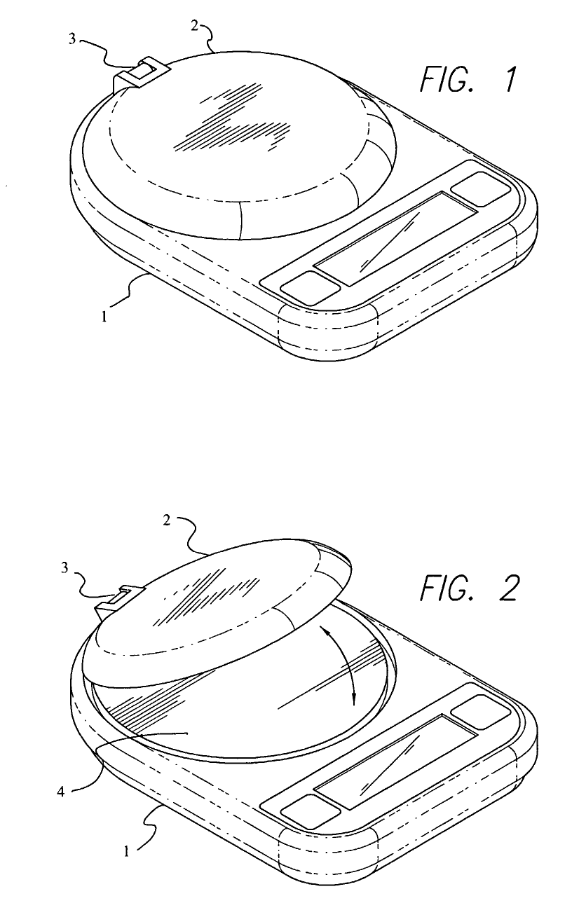

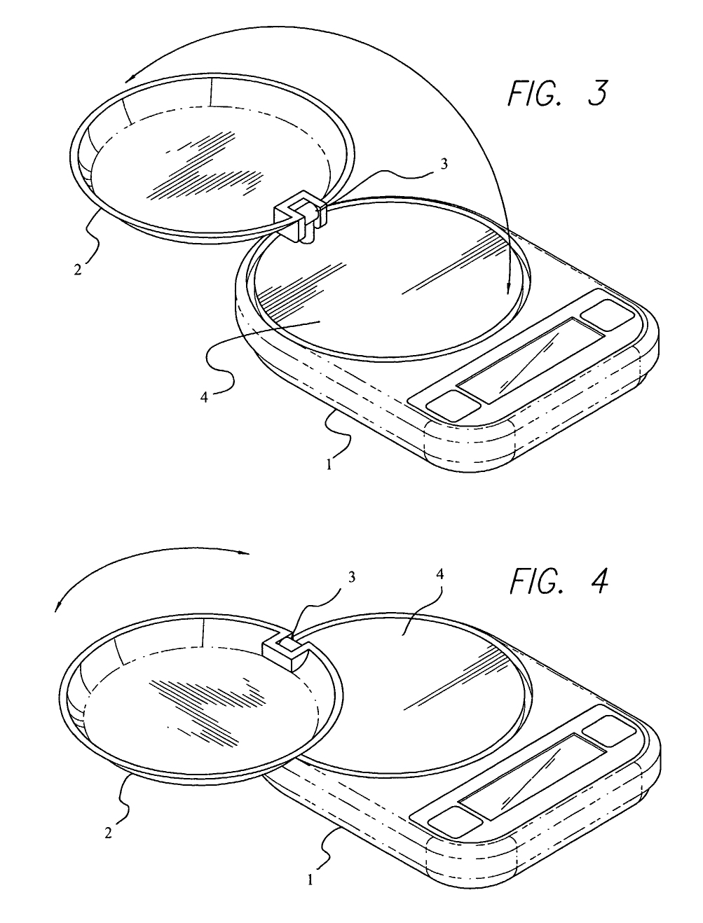

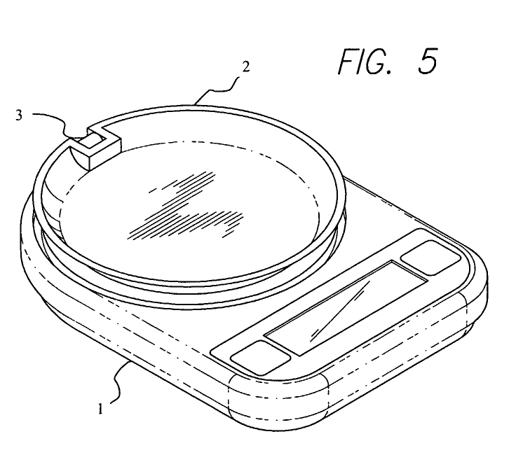

### DETAILED DESCRIPTION OF THE PREFERRED EMBODIMENT

The present invention is a small portable scale with a convertible cover 2. In the preferred embodiment, the convertible cover 2 is in the form of a shallow dish The convertible cover 2 of the portable scale covers the weighing surface 4 of the portable scale while the portable scale is in transport or in storage to protect the weighing surface 4 and the delicate sensors under the weighing surface 4 from being damaged due to impact or excessive pressure during transport or storage The convertible cover 2 is flipped open and rotated onto the weighing surface 4 when the portable scale is used to weigh objects. The convertible cover 2 acts as a holding dish to contain the small objects such that they will not roll or fall off the weighing surface 4 when they are being weighed and also to protect the weighing surface 4 from being damages by the objects being weighed.

In the preferred embodiment of the present invention, the convertible cover 2 of the portable scale is attached to the portable scale with a hinge 3 that allows the convertible cover 2 to freely rotate and turn about the hinge 3 In the preferred embodiment of the portable scale, the hinge 3 is in a T-shaped configuration The vertical post of the hinge 3 is inserted into the housing 1 of the portable scale and can be rotated freely about its axis. The horizontal post of the hinge 3 is rotably attached to the convertible cover 2 to allow the convertible cover 2 to rotate freely about the axis of the horizontal post. The combination of the movements allows the convertible cover 2 to be easily moved to any desired position about its hinge 3.

During transport or storage, the convertible cover 2 will remain closed with a snap tab that retains the convertible cover 2 to the housing 1 of the portable scale in its closed position, covering the weighting surface 4. During use, the convertible cover 2 is flipped open and rotated about its hinge 3 onto the weighing surface 4 when the portable scale is used to weigh objects In the preferred embodiment, the back of the convertible cover 2 may have one or more indentations that will engage one or more matching protrusions on the weighing surface 4 to prevent the convertible cover 2 from sliding around on the weighing surface 4 when it is opened and resting on the weighing surface 4. Once opened and rotated onto the weighing surface 4, the convertible cover 2 acts as a holding dish to contain the small objects so that they will not roll or fall off the weighing surface 4 when they are being weighed and also to protect the weighing surface 4 from being damages by the objects being weighed After use, the convertible cover 2 may be returned to its closed position for transportation or storage.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given

What is claimed is:

1. A portable scale comprising:
a scale with a weighing surface;
a convertible cover with a front surface and a back surface that is attached to said scale with a hinge,
wherein said convertible cover may be moved freely to any desired position about said hinge to cover and protect the weighing surface of said scale.

2. A portable scale as in claim 1, wherein the convertible cover is in the form of a shallow dish

3. A portable scale as in claim 1, wherein the hinge is in a T-shaped configuration with a vertical post and a horizontal post and wherein said vertical post of the hinge is inserted into said scale and can be rotated freely about its axis and said horizontal post of the hinge is rotably attached to said convertible cover to allow said convertible cover to rotate freely about the axis of said horizontal post

4 A portable scale as in claim 1, wherein said back surface of the convertible cover may have one or more indentations that will engage one or more matching protrusions on the weighing surface.

5. A portable scale comprising:
a scale with a weighing surface,
a convertible cover in the form of a shallow dish with a front surface and a back surface that is attached to said scale with a hinge;
wherein said convertible cover may be moved freely to any desired position about said hinge to cover and protect the weighing surface of said scale

6 A portable scale as in claim 5, wherein the hinge is in a T-shaped configuration with a vertical post and a horizontal post and wherein said vertical post of the hinge is inserted into said scale and can be rotated freely about its axis and said horizontal post of the hinge is rotably attached to said convertible cover to allow said convertible cover to rotate freely about the axis of said horizontal post

7. A portable scale as in claim 5, wherein said back surface of the convertible cover may have one or more indentations that will engage one or more matching protrusions on the weighing surface

8 A portable scale comprising:
a scale with a weighing surface,
a convertible cover in the form of a shallow dish with a front surface and a back surface that is attached to said scale with a hinge that is in a T-shaped configuration with a vertical post and a horizontal post wherein said vertical post of said hinge is inserted into said scale and can be rotated freely about its axis and said horizontal post of said hinge is rotably attached to said convertible cover to allow said convertible cover to rotate freely about the axis of said horizontal post,
wherein said convertible cover may be moved freely to any desired position about to cover and protect the weighing surface of said scale

9. A portable scale as in claim 8, wherein said back surface of the convertible cover may have one or more indentations that will engage one or more matching protrusions on the weighing surface
